(19) United States
(12) Patent Application Publication
(10) Pub. No.: US 2026/0049862 A1
(43) Pub. Date: Feb. 19, 2026

(54) WEIGHING DEVICE

(71) Applicant: TOCHTECH TECHNOLOGIES LTD., Delta (CA)

(72) Inventor: Wei FANG, Langley (CA)

(21) Appl. No.: 18/979,294

(22) Filed: Dec. 12, 2024

(30) Foreign Application Priority Data
Aug. 14, 2024 (CN) 202411113495.9

(51) Int. Cl. G01G 21/07; G01G 3/14

(52) U.S. Cl. CPC G01G 21/07; G01G 3/14

(57) ABSTRACT

A weighing device includes a bearing plate and at least three weighing units distributed at non-linear intervals on a lower plate surface of the bearing plate. The at least three weighing units stably support the bearing plate. A central portion of the bearing plate is oriented downwards. The central portion forms a load region for carrying a load. Flanges are formed on the ends of the central portion, with the flanges being configured to be attached to the weighing units. Under maximum load, the lower plate surface of the load region is not lower than the contact points of the weighing units with the ground surface.

### CROSS-REFERENCE TO RELATED APPLICATIONS

This application claims priority from Chinese Patent Application No. 202411113495.9 filed 14 Aug. 2024.

### TECHNICAL FIELD

The present disclosure relates to weighing devices, and in particular, to weighing devices comprising load cells.

### BACKGROUND

A load cell is a device that converts a force (e.g. tension, compression, pressure, etc.) into a measurable electrical signal. There are eight main types of load cells: photoelectric, hydraulic, electromagnetic, capacitive, magnetic pole change, vibration, gyroscopic, and resistance strain. Of these types, resistance strain load cells are among the most widely used type of load cells.

In a resistance strain load cell, an elastic element undergoes elastic deformation under the action of an external force. This causes a resistance strain gauge attached to a surface of the elastic element to also deform. When the resistance strain gauge deforms, its resistance changes, with these changes being detected and measured by a measurement circuit. The measurement circuit is configured to convert the changes in the resistance into an electrical signal. A transmission cable may be provided to communicate the electrical signal to other devices for further processing or use.

Typical weighing devices comprise a load-bearing plate with one or more load cells arranged under the load-bearing plate. When an external weight is placed on the load-bearing plate, the elastic elements and resistance strain gauges in the load cells deform, resulting in the measurement circuits of the respective load cells converting the changes in resistance of the resistance strain gauges into electric signals corresponding to the force exerted thereon (e.g. the force exerted by the external weight).

The load-bearing plate of a typical weighing device is generally flat, with the load cells arranged on a lower surface of the load-bearing plate. Accordingly, a suspended height of the external weight is equal to the sum of the thickness of the load-bearing plate and the load cells. In some scenarios, a suspended height (i.e. height of the center of gravity) of heavier objects should not be too high, such as, for example, for weighing devices installed under the foot or wheel of a sleep monitoring bed. If the suspended height of the foot or wheel of the bed is too high, and if the weight of the bed is too great, the stability of the bed will be reduced due to the upward shift in the center of gravity. This may result in a more difficult installation of the weighing device.

### SUMMARY

In one aspect, a weighing device comprises a bearing plate. At least three weighing units are distributed at non-linear intervals on a lower plate surface of the bearing plate, with the at least three weighing units stably supporting the bearing plate. A central portion of the bearing plate is oriented downwards. The central portion forms a load region for carrying a load. Flanges are formed on the ends of the central portion, with the flanges being configured to be attached to the weighing units. Under maximum load, the lower plate surface of the load region is not lower than the contact points of the weighing units with the ground surface.

In another aspect, a weighing device for measuring a weight of a load comprises a bearing plate and at least three weighing units. The bearing plate comprises upper and lower plate surfaces. The bearing plate further comprises a load region, two or more connector regions, and two or more flanges. The load region receives the load, with the load placed on the upper plate surface of the load region. The two or more connector regions extend angularly from the load region. Each of the two or more flanges extend angularly from one of the two or more connector regions. The at least three weighing units are distributed among the two or more flanges and are adapted to support the bearing plate on a ground surface. Each of the at least three weighing units comprises an elastic plate extending from one of the two or more flanges. Each of the at least three weighing units is configured to convert a detected degree of deformation caused by the load on the load region into electrical signals corresponding to the weight of the load. The upper plate surface of the load region is lower than the elastic plate of each of the at least three weighing units.

In still another aspect, the lower plate surface of each of the two or more flanges is between 1 mm and 4 mm above the upper plate surface of the load region.

In a further aspect, the at least three weighing units comprises four weighing units. Each of the four weighing units is located proximate to a corner of the bearing plate.

In still a further aspect, the load region is substantially planar.

In another aspect, each of the at least three weighing units further comprises a resistance strain gauge and a support member. The resistance strain gauge is attached to both the elastic plate and to the one of the two or more flanges. The support member is connected to the elastic plate and adapted to contact the ground surface. The point of contact between the support member and the ground surface is lower than the lower plate surface of the load region.

In still another aspect, the elastic plate and the bearing plate are formed from a single sheet of material.

In still yet another aspect, the resistance strain gauge is attached to the lower plate surface of the one of the two or more flanges.

In a further aspect, the elastic plate comprises upper and lower elastic plate surfaces, and the resistance strain gauge is attached to the lower elastic plate surface.

In still a further aspect, the elastic plate comprises a central beam attached to the one of the two or more flanges and two lateral beams extending on lateral sides of the central beam. The support member is adapted to connect to the lateral beams and spans across the central beam without touching the central beam.

In still yet a further aspect, the elastic plate further comprises a plate body. The central beam and the two lateral beams are attached to the plate body.

In another aspect, the support member comprises two wings and a central body extending between the two wings.

In still another aspect, each of the two wings is connected to one of the lateral beams.

In still yet another aspect, the weighing device further comprises fasteners for attaching each of the two wings to one of the lateral beams.

In a further aspect, the central body is arched and spans the central beam but does not come into contact with the central beam.

In still a further aspect, at least a portion of the resistance strain gauge extends between the central body and the central beam.

In still yet a further aspect, at least a portion of the central body is adapted to contact the ground surface.

In still a further aspect, the at least a portion of the central body that is adapted to contact the ground surface is located at approximately a midpoint of a length of the resistance strain gauge.

In another aspect, one or more of the resistance strain gauges is covered by a flexible sealant.

In yet another aspect, each of the resistance strain gauges is electrically connected to a controller interface using one or more wires.

In still yet another aspect, each of the resistance strain gauges is connected through the one or more wires to form a full-bridge circuit structure.

The suspended height of the load is equal to the height of the upper plate surface of the load region from the ground surface. Because the load region is formed by the downward bending and depression of the central part of the bearing plate, the upper plate surface of the load region may be lower than the upper plate surface of the flanges. The height above the ground surface may be less than the sum of the thickness of the flanges and the weighing units. Therefore, when the weighing device is used to weigh the load, the height of the load from the ground surface can be correspondingly reduced, thereby broadening the scope of application and enhancing the stability of the load during the weighing process.

The foregoing was intended as a summary only and of only some of the aspects of the invention. It was not intended to define the limits or requirements of the invention. Other aspects of the invention will be appreciated by reference to the detailed description of the preferred embodiments.

### BRIEF DESCRIPTION OF THE DRAWINGS

The invention will be described by reference to the detailed description of the embodiments and to the drawings thereof in which:

FIG. 1 depicts a top perspective view of the weighing device in accordance with one embodiment;

FIG. 2 depicts a bottom perspective view of the weighing device;

FIG. 3 depicts a side view of the weighing device;

FIG. 4 is a magnified view of the portion A of FIG. 3;

FIG. 5 depicts a top view of the weighing device;

FIG. 6 depicts a bottom view of the weighing device;

FIG. 7 depicts a magnified top perspective view showing one of the weighing units of the weighing device;

FIG. 8 depicts a magnified side view showing one of the weighing units; and

FIG. 9 depicts a magnified bottom perspective view showing one of the weighing units.

### DETAILED DESCRIPTION

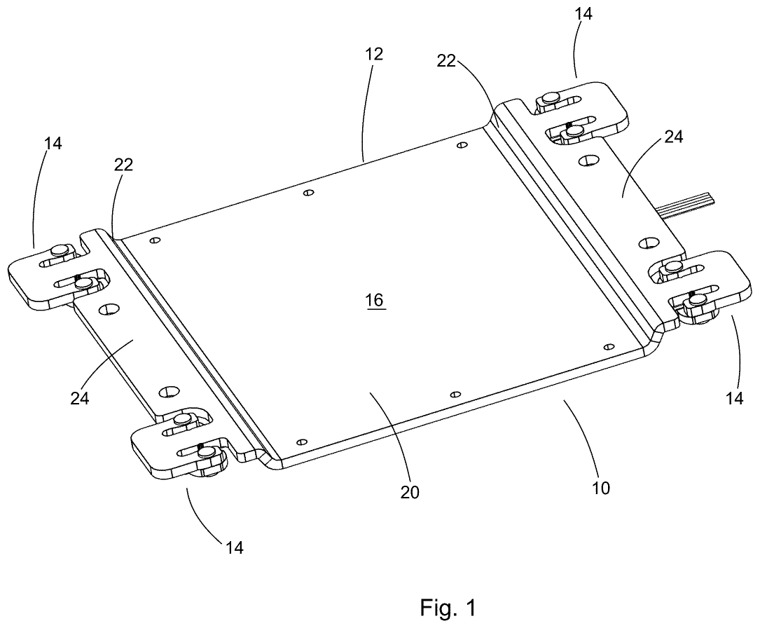

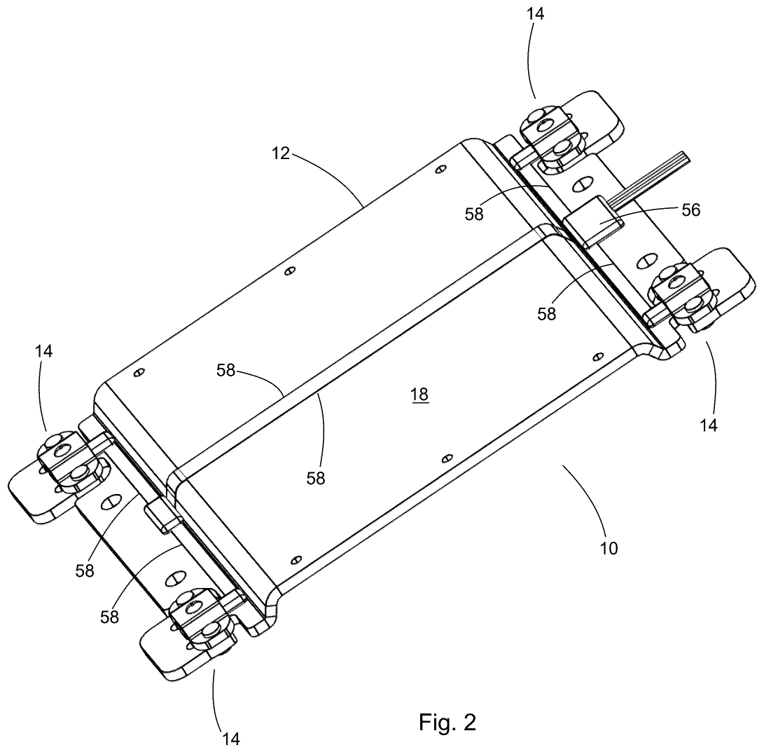

Referring to FIGS. 1 and 2, a weighing device 10 comprises a bearing plate 12 and a plurality of weighing units 14 extending from the bearing plate 12. The bearing plate 12 comprises upper and lower plate surfaces 16, 18 and may be made from metal, such as steel. The weighing units 14 may be distributed in a non-linear arrangement about the bearing plate 12. In some embodiments, the number of the weighing units 14 may be four; however, in other embodiments, the number of the weighing units 14 may be three, five, or more. The weighing units 14 may comprise load cells and may be adapted to stably support the bearing plate 12.

The bearing plate 12 may be bent to form a load region 20 for carrying or receiving a load 1. By way of example only, in the embodiment shown in FIG. 1, the bearing plate 12 comprises a load region 20 in between two connector regions 22, with a flange 24 extending from each of the two connector regions 22. The load region 20, the two connector regions 22, and the two flanges 24 may be formed by bending a single sheet of material, such as steel or some other suitable metal.

In some embodiments, the weighing units 14 may extend from the bearing plate 12 proximate to or at the flanges 24, as shown in FIG. 1. Each of the weighing units 14 may comprise a lower unit surface 26 (best shown in FIG. 4), with at least two of the lower unit surfaces 26 of the weighing units 14 simultaneously contacting a ground surface 2. Through contact by the lower unit surfaces 26 of the weighing units 14 with the ground surface 2, a stable base for the weighing device 10 may be formed.

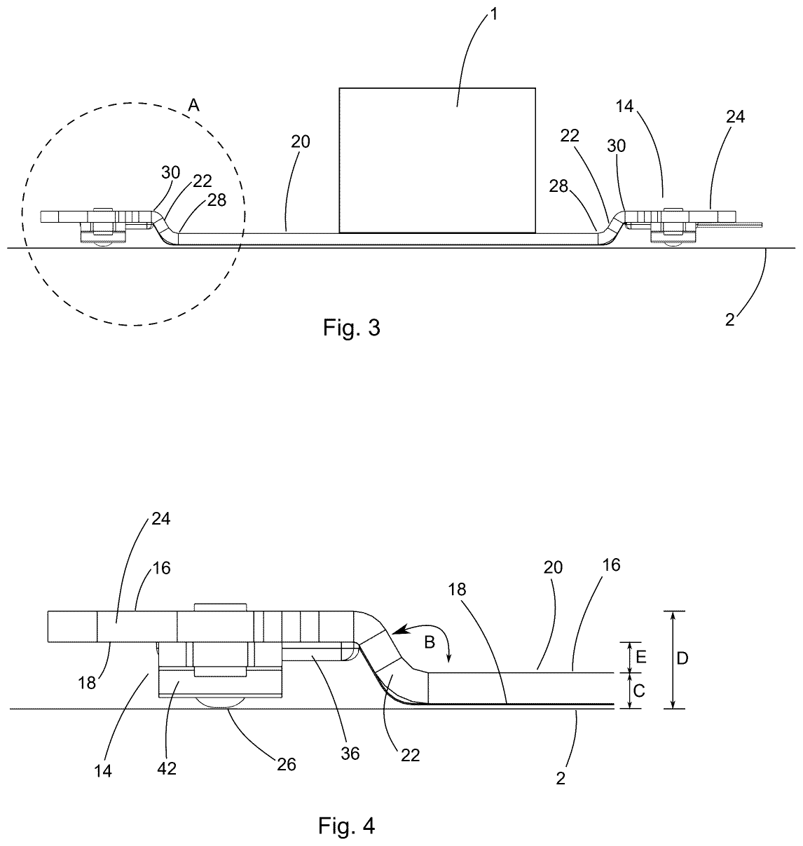

Referring to FIGS. 3 and 4, when the load 1 is placed on the load region 20, the weighing device 10 is configured such that the lower plate surface 18 is not lower than the lower unit surfaces 26 of the weighing units 14, even when the load 1 is at the maximum weight for the weighing device 10. In other words, the lower plate surface 18 should be above the lower unit surfaces 26.

In some embodiments, the weighing units 14 may be arranged proximate to the corners of the bearing plate 12, extending from the flanges 24. For example, two of the weighing units 14 may extend from each of the flanges 24, as shown in FIG. 1. The bearing plate 12 may be bent to form the load region 20, such as at two first edges 28 (in between the load region 20 and the connector regions 22). The load region 20 may be substantially rectangular in shape and may be substantially planar. In some embodiments, the load regions 20 may have a length of approximately 120 mm (i.e. the distance between the two first edges 28) and a width of approximately 100 mm, although it is understood that other dimensions are also possible. The flanges 24 may be formed by further bending the bearing plate 12 at two second edges 30 (in between the connector regions 22 and the flanges 24). The connector regions 22 may be angled with respect to the load region 20 and the flanges 24 (i.e. the connector regions 22 are not necessarily perpendicular to the load region 20 or the flanges 24). For example, in some embodiments, an angle B between the load region 20 and the connector regions 22 (as shown in FIG. 4) may be between 100°and 140°. In some embodiments, the angle B may be approximately 120°. It is understood that other values for the angle B are also possible.

In some embodiments, the shape of the bearing plate 12 may take on other forms, such as a hexagon, a pentagon, a triangle, or the like.

When the load 1 is placed or engaged on the upper plate surface 16 of the load region 20, downward pressure is applied to the load region 20. This downward pressure is transferred through the connector regions 22 to the flanges 24, which in turn causes pressure to be applied against the weighing units 14. This pressure may be measured by the weighing units 14. At the same time, the downward pressure exerted on the load region 20 may cause the lower plate surface 18 of the load region 20 to move lower. However, even when the load 1 is at the maximum weight for the weighing device 10, the lower plate surface 18 is still above the contact points between the lower unit surfaces 26 of the weighing units 14 and the ground surface 2. This prevents the load region 20 from contacting the ground surface 2, which would affect the measurements taken by the weighing units 14.

In some embodiments, the weighing device 10 may be placed on a support base, rather than directly on the ground surface 2. However, the operation of the weighing device 10 may still be similar to that disclosed herein.

Referring to FIG. 4, the suspended height of the load 1 may be equal to the height of the upper plate surface 16 of the load region 20 from the ground surface 2. This is because the load region 20 is formed by bending the bearing plate 12 to form a relatively depressed area with respect to the flanges 24 (e.g. where the weighing units 14 may be located). In other words, the upper plate surface 16 of the load region 20 may be lower than the upper plate surface 16 of the flanges 24. A height C of the upper plate surface 16 of the load region 20 from the ground surface 2 may be less than the sum D of the thickness of the flanges 24 and the thickness of the weighing units 14.

In some embodiments, a difference between D and C may be between 4 mm and 6 mm (i.e. a distance between the upper plate surface 16 of the flange 24 and the upper plate surface 16 of the load region 20). In some embodiments, the difference between D and C may be approximately 5 mm.

In some embodiments, the bearing plate 12 may be between 2 mm and 3 mm. In some embodiments, the bearing plate 12 may be approximately 2.5 mm thick.

Accordingly, a distance E between the lower plate surface 18 of the flange 24 and the upper plate surface 16 of the load region 20 may be between 1 mm and 4 mm. Where the difference between D and C is approximately 5 mm and where the bearing plate 12 is approximately 2.5 mm thick, the distance E may be approximately 2.5 mm.

Therefore, when the weighing device 10 is used to measure or weigh the load 1, a height of the load 1 from the ground surface 2 (i.e. a height of the center of gravity of the load 1) can be reduced in comparison to a completely planar bearing plate 12. This allows the weighing device 10 to be used in a larger range of applications and also enhances the stability of the load 1 during the weighing process.

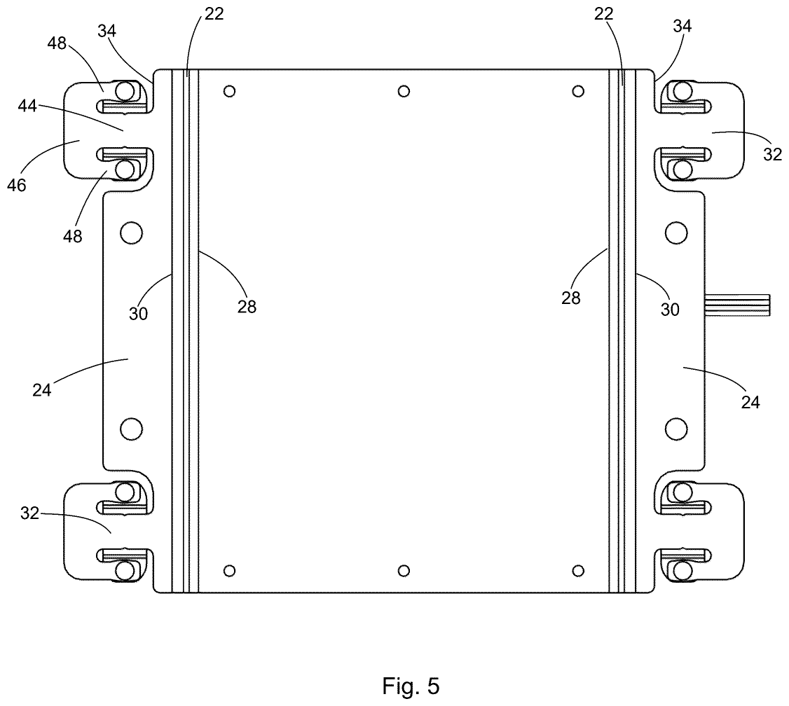

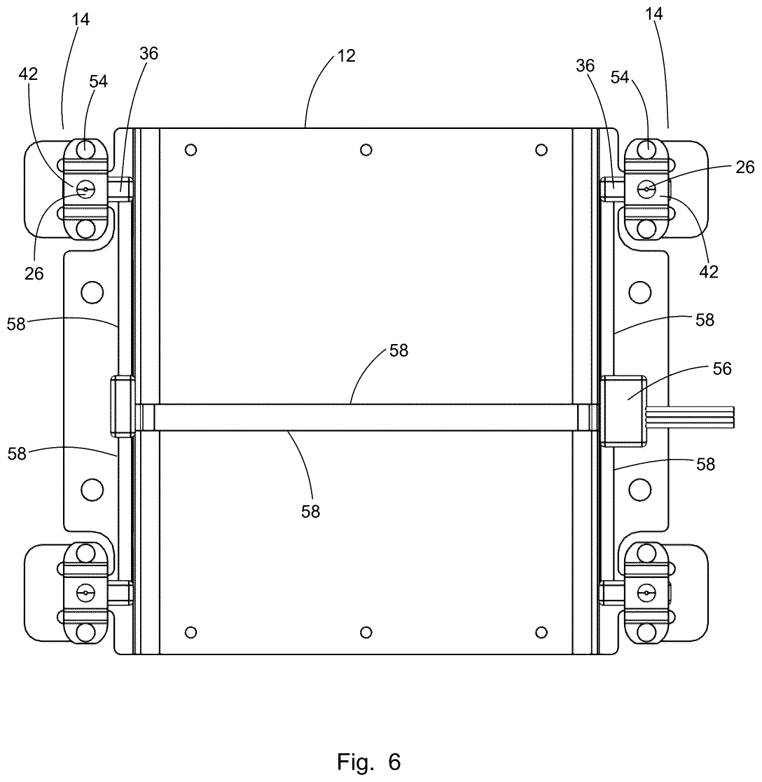

Referring to FIGS. 5 and 6, the flanges 24 may comprise outer flange edges 34 that extend proximate to the corners of the bearing plate 12. Each of the weighing units 14 comprises an elastic plate 32 that may extend from the outer flange edges 34. The elastic plate 32 may comprise upper and lower elastic plate surfaces 38, 40. In some embodiments, the elastic plate 32 is continuous and unitary with the flanges 24. In other words, the elastic plate 32 may be formed from the same sheet of material as the flanges 24 (and also possibly the bearing plate 12), as shown in FIG. 5. In other embodiments, the elastic plate 32 may instead be connected to the flanges 24, such as to the lower plate surface 18 of the flanges 24. Each of the weighing units 14 may further comprise a resistance strain gauge 36 extending across at least part of the elastic plate 32 and at least part of the flange 24. In some embodiments, the resistance strain gauge 36 may be attached to a portion of the lower plate surface 18 of the flanges 24 and to a portion of the lower elastic plate surface 40. In other embodiments, the resistance strain gauge 36 may be attached to a portion of the upper plate surface 16 and to a portion of the upper elastic plate surface 38.

Each of the weighing units 14 may further comprise a support member 42 that may be attached to the lower elastic plate surface 40. The support member 42 defines, at least in part, the lower unit surface 26 and may be in contact with the ground surface 2. The point of contact between the support member 42 and the ground surface 2 is no higher than the lower plate surface 18 of the load region 20 under maximum load.

When the weighing device 10 is placed on the ground surface 2 through contact by the support members 42 with the ground surface 2, the bearing plate 12 and the elastic plates 32 may be in a suspended state (i.e. suspended by the resistance strain gauge 36). When the load 1 is placed on the load region 20, upward bending occurs at the intersection between the elastic plates 32 and the flanges 24. Since the resistance strain gauges 36 span across both the elastic plates 32 and the flanges 24 (being attached to the lower elastic plate surfaces 40 and to the lower plate surface 18 of the flanges 24), the resistance strain gauges 36 will also experience similar upward bending, resulting in a measureable change in resistivity in the resistance strain gauges 36.

In some embodiments, the elastic plates 32 and the bearing plate 12 may be stamped or formed from the same sheet of material. In such embodiments, the resistance strain gauges 36 will be attached to the same sheet of material (e.g. steel). Under such circumstances, the performance consistency by using the same sheet of material is relatively strong. Under the action of the load 1, the degree of bending or curvature between the elastic plates 32 and the flanges 24 may be relatively consistent for each of the weighing units 14, resulting in greater measurement accuracy.

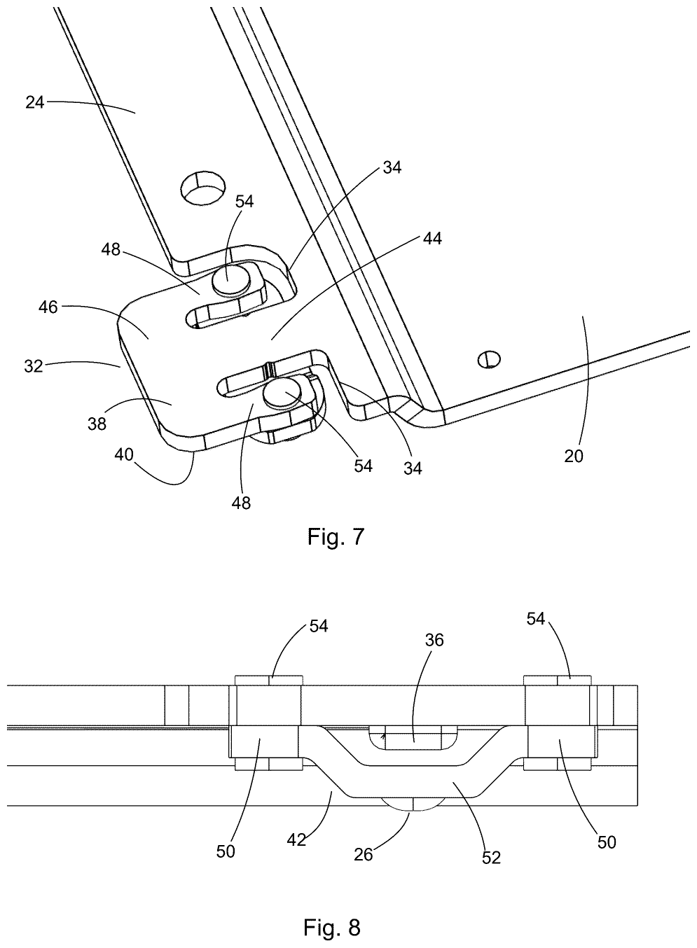

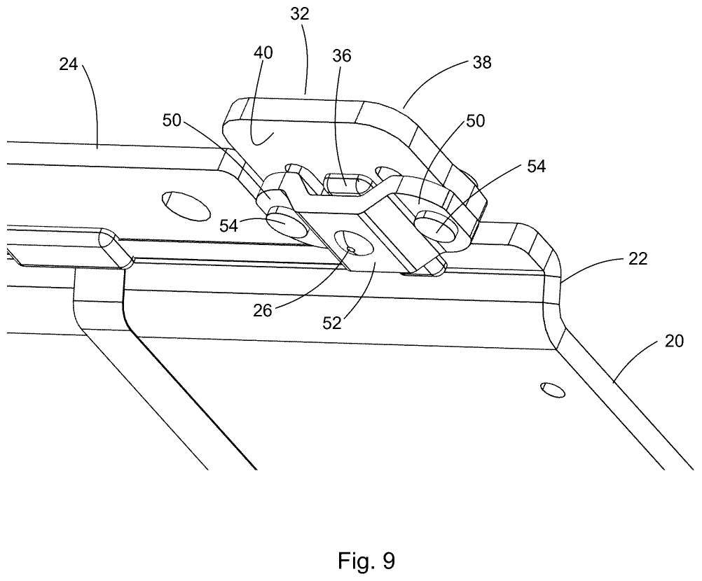

Referring to FIGS. 7 to 9, in some embodiments, the elastic plates 32 comprise a central beam 44 and a plate body 46 extending from the central beam 44. The central beam 44 is attached to the flange 24. The elastic plates 32 further comprise lateral beams 48 that extend from the plate body 46 and extend at least partially along a length of the lateral sides of the central beam 44. The lateral beams 48 may not contact the outer flange edge 34. In some embodiments, the lateral beams 48 are arranged symmetrically along the lateral sides of the central beam 44.

The support members 42 may comprise two wings 50, with a central body 52 extending between the two wings 50. Each of the wings 50 may be configured to engage with and be connected to one of the lateral beams 48, such as using fasteners 54. The fasteners 54 may be pins, bolts, rivets, screws, or the like. The central body 52 may be arch-shaped and may span the central beam 44 but without coming into contact with the central beam 44. In some embodiments, at least a portion of the resistance strain gauge 36 extends above the central body 52. At least a portion of the resistance strain gauge 36 extends between the central body 52 and the central beam 44

The central beam 44 is attached to the flange 24 to ensure the accuracy of any force transmission. If the lateral beams 48 are arranged symmetrically along the lateral sides of the central beam 44, the stability of and the force transmission by the elastic plate 32 is enhanced. The accuracy of the force, on the other hand, also provides an installation basis for the support members 42, thereby improving the stability of the weighing device 10 overall. At least a portion of the central body 52 may comprise the lower unit surface 26.

In some embodiments, the lower unit surface 26 may be oriented below approximately a midpoint of a length of the resistance strain gauge 36. In some embodiments, the resistance strain gauge 36 may also extend longitudinally along approximately a midline between two of the fasteners 54 used to connect the wings 50 to the lateral beams 48.

In some embodiments, the resistance strain gauges 36 may be covered with a flexible sealant, which not only increases the accuracy of force transmission but also provides protection for the resistance strain gauges 36 and prevents them from being contaminated by the outside, thereby increasing the service life of the weighing device 10.

Referring again to FIG. 2, in some embodiments, the resistance strain gauges 36 may be electrically connected to a controller interface 56 provided on the weighing device 10 using one or more wires 58. The resistance strain gauges 36 may be configured to bend under force and convert the force detected by it into an electrical signal, which is in turn transmitted to the controller interface 56 using the wires 58. The controller interface 58 may be configured to use the electrical signals received from the resistance strain gauges 36 to determine a weight of the load 1. Depending on the location of the load 1 on the load region 20, the amount of strain experienced by each of the resistance strain gauges 36 may be different, which may result in different electrical signals transmitted by the resistance strain gauges 36. The controller interface 56 may be configured to take into account different electrical signals from the resistance strain gauges 36 in order to determine the weight of the load 1. An external controller may also be connected to the controller interface 56 to read the electrical signals from the resistance strain gauges 36.

In some embodiments, each of the resistance strain gauges 36 may be connected by the wires 58 to form a full-bridge circuit structure (e.g. a Wheatstone bridge), thereby reducing the number of the wires 58 required to connect the resistance strain gauges 36 to the external controller. This may improve reliability and stability of the weighing device 10, as well as make assembly of the weighing device 10 easier.

It will be appreciated by those skilled in the art that the preferred embodiment has been described in some detail but that certain modifications may be practiced without departing from the principles of the invention.

1. A weighing device for measuring a weight of a load, the weighing device comprising:
a bearing plate with upper and lower plate surfaces, the bearing plate comprising:
a load region for receiving the load, wherein the load is placed on the upper plate surface of the load region;
two or more connector regions extending angularly from the load region;
two or more flanges, each of the two or more flanges extending angularly from one of the two or more connector regions; and
at least three weighing units distributed among the two or more flanges and adapted to support the bearing plate on a ground surface, wherein each of the at least three weighing units comprises an elastic plate extending from one of the two or more flanges, and wherein each of the at least three weighing units is configured to convert a detected degree of deformation caused by the load on the load region into electrical signals corresponding to the weight of the load;
wherein the upper plate surface of the load region is lower than the elastic plate of each of the at least three weighing units.

2. The weighing device of claim 1, wherein the lower plate surface of each of the two or more flanges is between 1 mm and 4 mm above the upper plate surface of the load region.

3. The weighing device of claim 1, wherein the at least three weighing units comprises four weighing units, and wherein each of the four weighing units is located proximate to a corner of the bearing plate.

4. The weighing device of claim 1, wherein the load region is substantially planar.

5. The weighing device of claim 1, wherein each of the at least three weighing units further comprises:
a resistance strain gauge attached to both the elastic plate and to the one of the two or more flanges; and
a support member connected to the elastic plate and adapted to contact the ground surface;
wherein the point of contact between the support member and the ground surface is lower than the lower plate surface of the load region.

6. The weighing device of claim 5, wherein the elastic plate and the bearing plate are formed from a single sheet of material.

7. The weighing device of claim 5, wherein the resistance strain gauge is attached to the lower plate surface of the one of the two or more flanges.

8. The weighing device of claim 5, wherein the elastic plate comprises upper and lower elastic plate surfaces, and wherein the resistance strain gauge is attached to the lower elastic plate surface.

9. The weighing device of claim 5, wherein the elastic plate comprises:
a central beam attached to the one of the two or more flanges; and
two lateral beams extending on lateral sides of the central beam;
wherein the support member is adapted to connect to the lateral beams and spans across the central beam without touching the central beam.

10. The weighing device of claim 9, wherein the elastic plate further comprises a plate body, wherein the central beam and the two lateral beams are attached to the plate body.

11. The weighing device of claim 10, wherein the support member comprises:
two wings; and
a central body extending between the two wings.

12. The weighing device of claim 11, wherein each of the two wings is connected to one of the lateral beams.

13. The weighing device of claim 12, wherein the weighing device further comprises fasteners for attaching each of the two wings to one of the lateral beams.

14. The weighing device of claim 12, wherein the central body is arched and spans the central beam but does not come into contact with the central beam.

15. The weighing device of claim 14, wherein at least a portion of the resistance strain gauge extends between the central body and the central beam.

16. The weighing device of claim 15, wherein at least a portion of the central body is adapted to contact the ground surface.

17. The weighing device of claim 16, wherein the at least a portion of the central body that is adapted to contact the ground surface is located at approximately a midpoint of a length of the resistance strain gauge.

18. The weighing device of claim 5, wherein one or more of the resistance strain gauges is covered by a flexible sealant.

19. The weighing device of claim 5, wherein each of the resistance strain gauges is electrically connected to a controller interface using one or more wires.

20. The weighing device of claim 19, wherein each of the resistance strain gauges is connected through the one or more wires to form a full-bridge circuit structure.
